(19) United States
(12) Patent Application Publication
(10) Pub. No.: US 2008/0139167 A1
(43) Pub. Date: Jun. 12, 2008

(54) Communications Control Method And Apparatus

(76) Inventor: Shelia Jean Burgess, Haymarket, VA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/968,509

(22) Filed: Jan. 2, 2008

Related U.S. Application Data
(63) Continuation-in-part of application No. 11/281,198, filed on Nov. 16, 2005, now abandoned.
Application No. 11/281,198 is a continuation of application No. 10/056,246, filed on Jan. 24, 2002, now abandoned.
Application No. 10/056,246 is a continuation-in-part of application No. 09/293,041, filed on Apr. 16, 1999, now Pat. No. 6,359,970.

(51) Int. Cl. H04M 11/04; G06F 15/177; G06N 5/00

(52) U.S. Cl. 455/404.1; 709/228; 706/59; 379/45

(57) ABSTRACT

A communications controller is provided for empowering the user of a communications device, such as a telephone or other device, to assume control over incoming communications. Each originator of a communication is identified by unique identification information as information associated with an incoming communication. The user of a receiving communication device selects one of a plurality of different priority levels for a particular originator of a communication. The user also selects block time intervals for each priority to indicate times during which communication will not be passed to user's communications device or other appropriate action is to be taken. When that particular originator of a communication initiates a communication to the user, the user's communication controller determines the originator's identification information and recalls the priority and corresponding blocking time interval for that particular identity. The communication is accordingly permitted to alert the user or blocked with the exception of conditional filtering. Conditional filtering permits the originator of a communication to send a conditional communication along with situational awareness information that is processed specifically for the particular situation. Conditional filtering includes the case of an emergency communication that would override normal communication control. A cognition engine is used to support conditional communication along with an event session. Intelligent data is created and used to support said event sessions.

### SPECIFIC DATA RELATED TO THE INVENTION

This application is a continuation-in-part to U.S. application Ser. No. 11/281,198, filed Nov. 16, 2005, which is a continuation of U.S. application Ser. No. 10/056,246, filed Jan. 24, 2002 which is a continuation-in-part of U.S. application Ser. No. 09/293,041 filed Apr. 16, 1999, now U.S. Pat. No. 6,359,970, which issued Mar. 19, 2002.

### BACKGROUND OF THE INVENTION

This invention relates in general to apparatus and methodology for controlling communications devices. More particularly, the invention relates to apparatus and methodology for permitting a user to control incoming communications supplied to a communications device such as a telephone in one example.

Today's consumer is being constantly bombarded and harassed by an ever-increasing volume of unwanted solicitation phone calls. Fundamentally, solicitors are using the passive telephone device to invade the general public's privacy at any time or within any domain that the solicitors choose. This level of harassment is especially annoying when it comes from a high-pressure and persistent telemarketing source. When posed with the question: “Would you purchase a telephone that would inhibit solicitors from calling you?” The answer is always an emphatic “YES!”

It is very desirable to provide telephone users with the capability of limiting their exposure to such unwanted telephone calls at the user's option. One conventional approach to this problem is the combined telephone/answering machine which permits the user to listen to the caller and then make a real time decision as to whether or not to pick up the telephone receiver and engage the caller. This is referred to as “call screening” in its most basic form. Of course, the user also has the option of listening to the caller's message at a later time and then making a decision as to whether or not to call back.

Another method of limiting the user's exposure to unwanted phone calls is described in U.S. Pat. No. 5,060,255 to Brown entitled “Telecommunications System With Timed-Do-Not-Disturb”. This patent discloses a telephone system that enables a subscriber to designate time periods during which no incoming calls are to be received over the subscriber line. Any calls dialed to the subscriber directory number at such times are diverted to a voice response unit that issues an appropriate announcement to inform the caller of the unavailability of the dialed number station. This timed call block feature is implemented in the telephone company's central office or switching facility.

Another call screening approach is disclosed in U.S. Pat. No. 5,467,388 issued to Redd, Jr. et al. entitled “Method And Apparatus For Selectively Blocking Incoming Telephone Calls”. In that patent, a system is disclosed for allowing a telephone subscriber to selectively block incoming calls for selected time periods or during programmed time intervals. In this approach, the call screening is again conducted at the telephone company's central office or switching facility.

One more conventional call screening technique is described in U.S. Pat. No. 4,277,649 issued to Sheinbein entitled “Method And Apparatus For Screening Telephone Calls”. In that patent, a telephone system is disclosed in which a called customer or user can screen calls incoming to his station based on the identity of the calling line. The calling line's identity is forwarded to the switching office containing the called customer's screening memory. The memory is interrogated to ascertain the call disposition based on information previously put in the memory by the called customer. In this approach, the screening process is once again dependent on screening conducted at the telephone company's central office or switching facility at which a centralized database is located.

Interoperability in the context of public safety communications systems refers to the ability of first responders to communicate with whomever they need to (including personnel from a variety of agencies and jurisdictions), when they need to, and when they are authorized. Different first responder groups each have different professional practices, public safety missions, emergency response procedures, communication protocols, and radio frequencies. These differences have created a variety of obstacles to provide interoperable communications among first responders as we have witnessed during 9/11, Rita, and Katrina to name a few. Thus facilitating interoperable communications has been a big policy concern of public safety official for many years. A strong urgent need exists to support interoperability especially as required by the National Incident Management System (NIMS) as it seeks incident response from local jurisdictions that escalate to national level support requiring varying degrees of security and intelligence. Response time is critical and responders need a means for standardized interoperability that also protects data and information while providing them with critical decisions and insight to resolve the incident/threat. There also exists a need for intelligent data, data that possesses means to reason and self-manage, that mitigates the risk of a compromised data situation wherein data is stolen or misappropriated or compromised.

### SUMMARY OF THE INVENTION

Accordingly, one object of the present invention is to provide a method and apparatus for limiting a communications device user's exposure to undesired communications by employing advanced control mechanisms implemented at or near the communications device.

Another object of the present invention is to provide a method and apparatus for limiting the user's exposure to undesired communications by employing advanced control mechanisms at the telephone service switcher and which are provided to the consumer as a service.

Another object of the invention is to provide communications device control methodology and apparatus which permits the consumer to proactively take control of how, when, and if the consumer responds to incoming communications.

Yet another object of the invention is to provide a methodology and apparatus for transforming the communications device (e.g., telephone, computer, and/or television) from a passive device to a controllable device that incorporates individual time management values and customized consumer priorities.

One more object of the invention is to provide a communications device control apparatus in which incoming communications are managed and controlled depending on the time-of-day, frequency, type, duration, and priority rating of the particular communications being received.

Another object of the invention is to provide a communications means to support conditional communication, more particularly for varying degrees of priority or emergency communication and support for interoperability.

Another object of the invention is to provide a means for cognition, cognitive data, and intelligent data.

Another object of the invention is to provide a means for data to protect itself, self-manage and provide self-analysis.

Another object of the invention is to provide a means to intelligently process emergency communication and conditional communication.

Another object of the invention is to mitigate false alerts from government issued or enterprise issued alerts.

Another object of the invention is to provide a means to mitigate success of malicious activity as it relates to conditional communication and emergency communication.

Another objective of the invention is to provide end-to-end authentication for communication.

Another objective of the invention is to provide intelligent situational awareness communication processing in one case to first responders of an incident.

Another objective of the invention is to provide conditional communication supportive of intelligent situational awareness communication processing.

Another objective of the invention is to use speech recognition in support of conditional communication and use a speech recognition means that is shared among parties.

Another objective of the invention is to generate data that possesses attributes that can be leveraged with Intelligent Agents (IAs) to provide intelligent means for the data so it can make decisions (e.g., self-destruct, analyze situation/data, etc.).

Another objective of the invention is to provide an emergency communication mode for communication solutions.

Yet another objective of the invention is to provide conditional filtering wherein conditional communication activates functions in support of the condition of the communication (i.e., functions are activated based on the condition of the communication).

In accordance with one embodiment of the present invention, a method is provided for processing an incoming communication from a calling party sent to a communications device of a receiving party. The disclosed method includes the step of storing a caller database including a plurality of records. Each record includes caller identification information corresponding to a particular caller and a respective priority selected from a plurality of priorities. The method also includes the step of storing a blocking time database including a plurality of records respectively corresponding to the plurality of priorities and further including respective blocking time information for each priority. An incoming communication including caller identification information is received. The time that the incoming communication is received is determined to provide a call received time.

The caller database is then searched to find a record having caller identification information matching the caller identification information of the incoming communication and the respective priority for that record is retrieved to produce a retrieved priority. The blocking time database is searched to determine blocking time information associated with the retrieved priority to produce retrieved blocking time information. The call received time of the incoming communication is compared with the retrieved blocking time information. The method further includes the step of blocking the incoming communication if the call received time occurs during a blockout time indicated by the retrieved blocking time information and otherwise permitting the incoming communication to be routed to the user of the communications device. The method further includes the step to check if the call being blocked is an emergency call that will be routed according to the consumer pre-selected options.

Upon a user of a communication device initiating a conditional communication such as an emergency communication, the communication mode of the said communication solution is set to the perspective conditional operation mode (emergency) and a real-time cognition engine (RTCE) event session is launched. The sending party initiates the conditional communication which the receiving party's communication controller determines is allowed or blocked. If allowed, the receiving party's communication device is set to the appropriate conditional operation mode (emergency mode) and access is activated to the RTCE event session. Security and authentication processing means along with encryption are employed. A log of an event session is created.

A Multi-Agent System (MAS) uses Intelligent Agents (IAs) for speech recognition interface means; security and authentication; access, analysis, and control of applications, services, expert systems, databases/data repositories, and media; situational awareness; and communication quality and priority. Intelligent data is created by a data creator process to support an event session by a participant. The intelligent data structure possesses attributes comprising ownership, identity, time/date of creation, source, data identity, age, timer, counters, tags, allowable actions, and data. Data handlers are IAs that applies rules and prior knowledge to take actions on the intelligent data. Data handler examples comprise security, tracker, life and analysis handlers.

### BRIEF DESCRIPTION OF THE DRAWINGS

The features of the invention believed to be novel are specifically set forth in the appended claims. However, the invention itself, both as to its structure and method of operation, may best be understood by referring to the following description and accompanying drawings.

FIG. 1 is a functional block diagram showing the overall relationship of the disclosed Communications Controller relative to other telecommunication device functions.

FIGS. 2A and 2B are the flow diagrams of the Communications Controller system operation.

FIG. 3 depicts the structure of a Caller ID database as it relates to the primary fields needed to support the processing logic of the Communications Controller.

FIG. 4 depicts the structure of a Time Block database as it relates to the primary fields needed to support the processing logic of the Communications Controller.

FIG. 5 depicts the look-up-table structure, which provides operational settings that are consequential functions related to the incoming call time and caller priority conditions.

FIG. 6 is a flow diagram depicting the unique Fuzzy Logic controller system operations.

FIG. 7 is a graph depicting a representation of the Time Block Fuzzy Set membership.

FIG. 8 is a graph depicting a representation of the Caller Priority Fuzzy Set membership.

FIG. 9 is a graph depicting a representation of the consequential Communications Controller Operations Fuzzy Set membership. This representation uses singletons to map directly to crisp solutions.

FIG. 10 is a block diagram of the hardware needed to support the Communications Controller. The implementation of the hardware can either be as a standalone unit that interfaces to Instantaneous Response Device, Messaging Response Device, and Caller Identification Device functions or an integrated element/feature set.

FIG. 11 is a functional block diagram showing the overall Communications System.

FIG. 12 is a diagram depicting the user interface phone device elements needed for emergency conditional communication.

FIG. 13 is a flow diagram for emergency conditional communication processing.

FIG. 14 is an Event Session main window.

FIG. 15 is a functional block diagram showing the overall components of a simple Intelligent Agent structure.

FIG. 16 is an Event Session Data window.

### DETAILED DESCRIPTION OF THE INVENTION

The disclosed Communications Controller virtually rids the receiving party of constant, non-value-added disruptions from unwanted incoming communications (e.g., phone calls and/or electronic media). Advantageously, the disclosed controller enables consumers to regain value-added control of their personal time.

For purposes of illustration only, and not to limit generality, the Communications Controller will be explained with reference to its use in processing incoming telephone calls as one example of its application. The Communications Controller includes automated control logic that intelligently integrates communication routing and screening functions. The controller manages and controls incoming communications depending on the time-of-day, frequency, type, duration, and priority rating of the received communication.

The disclosed Communications Controller enables the consumer to effectively control the time of day or night that a phone call is permitted to ring/announce an incoming call. It also permits the consumer to establish priorities for incoming calls. These priorities are then used to automatically route calls through the phone and to the consumer in a manner that suits the consumer's specific needs and values. If desired, unwanted incoming phone calls (e.g., from solicitors and harassers) will not even ring. Therefore, at the option of the receiving party, the receiving party is not disturbed. The disclosed controller advantageously transforms the telephone into a controllable device which provides efficient and effective timely, value-added communication.

The disclosed communications controller is first described as it functionally relates to other telecommunication device functions. Later, representative hardware for implementing the controller is described in detail.

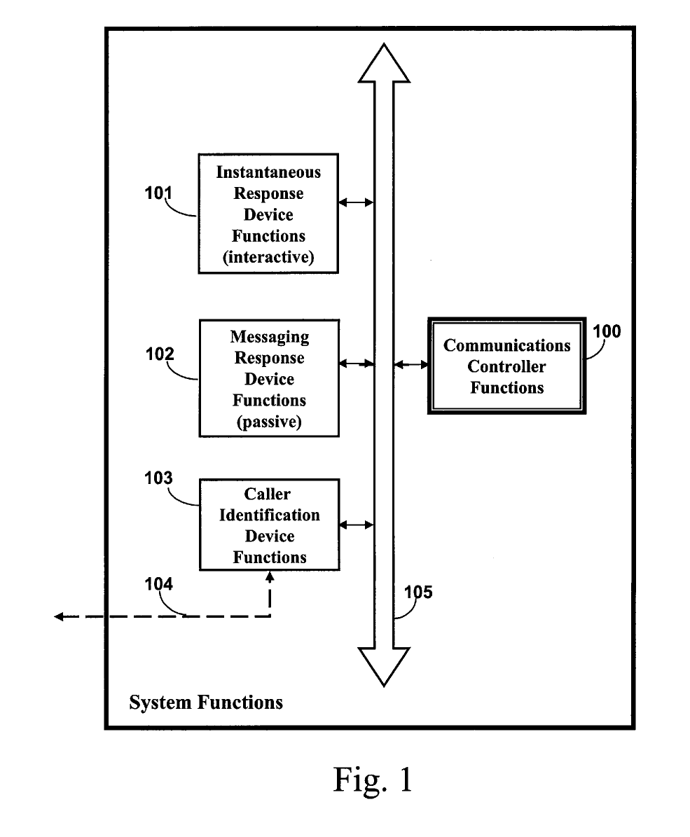

More particularly, FIG. 1 is a functional block diagram showing the overall relationship of the disclosed Communications Controller 100 relative to other telecommunication device functions. The processing provided to a particular incoming telephone call by the Communications Controller is time and incoming call priority dependent. It is noted that the Communications Controller and associative control logic can be applied and implemented as a consumer product along with other consumer telephony devices (e.g. telephones, answering machines, Caller ID devices, computers, telephone/television solutions). The Communications Controller can also be implemented at the telephone service switcher and provided to the consumer as a telephone service.

In one embodiment, the Instantaneous Response Device Functions 101, Messaging Response Device Functions 102, and Caller Identification Device Functions 103 may be implemented as an integrated device or independently to support the Communications Controller Functions 100 as indicated in FIG. 1.

The Instantaneous Response Device Functions 101 (e.g., telephone device) provide the interactive support needed for a communications device such as a telephone. Examples of the support this device provides are ring/announce, call forward, call waiting, and paging the user for immediate response to the incoming call.

The Messaging Response Device Functions 102 (e.g., answering machine) provide the passive support needed for a communications device. Examples of the support this device provides are to play, store, and record message data (e.g., voicemail, email, multimedia mail) to which the user can respond at their convenience but not necessarily during the time the call/contact is being placed or made. The communications line 104 (e.g., a telephone line or cable) that connects to other communication devices is coupled to the Caller Identification Device Functions 103.

The Caller Identification (ID) Device 103 sends incoming call data such as Caller ID data to Communications Controller 100. Communications Controller 100 processes incoming calls using the Caller ID data received. If the incoming Caller ID data is not available for a particular incoming call, then Communications Controller 100 uses Messaging Response Device (e.g. Answering Machine) Functions 102 to play an Out Going Message (OGM) prompting the caller for their identification data. Upon the Communications Controller 100 attempting to obtain this data, it will continue processing the call. As a result, the Communications Controller 100 will either use the:

1) Instantaneous Response Device Functions 101 to ring/announce via the telephone device, forward the call, page the person being called, support remote control of the device, terminate the call, notify the user of call waiting via a specific beep indication or,

2) Messaging Response Device (e.g., Answering Machine) Functions 102 to play an appropriate OGM and permit the caller to leave a message.

The interface 105 supports communications to transmit and route data among the above described system functions in FIG. 1.

Incoming Caller ID data can either be originating device dependent (identifier associated to the call origination device) or caller dependent (identifier associated to the individual caller/person). Consumer products for the Caller Identification Device Functions 103 using today's technology are device dependent—they provide the caller's phone number and/or name. However, depending on the implementation of the Communications Controller 100, this data could be the I.P. Address of a node on a network or other device identifier data. Conversely, caller dependent Caller ID data can utilize such elements as:

1) Caller personal account data (e.g., account number, email address, Internet address, etc.);

2) Speaker dependent voice data—person identifying themselves by speaking their name in order to capture their temporal phonic signal data; and

3) Video data—a video frame of a caller's unique identifiers (e.g., the caller's face, retinal scan, finger/thumb print, etc.)

In this embodiment, the Communications Controller 100 is not dependent on the Caller ID data/media type. Rather, controller 100 merely conforms to the data type being used by the Caller Identification Device Functions 103, which is an external interface to Communications Controller 100. Communications Controller 100 merely utilizes this data associated with the caller regardless of its type (e.g., device dependent or caller dependent) to determine the given priority of the caller. (Communications Controller 100 uses the incoming Caller ID data to attempt to match this data with the Caller ID data stored in its database for a call priority determination.)

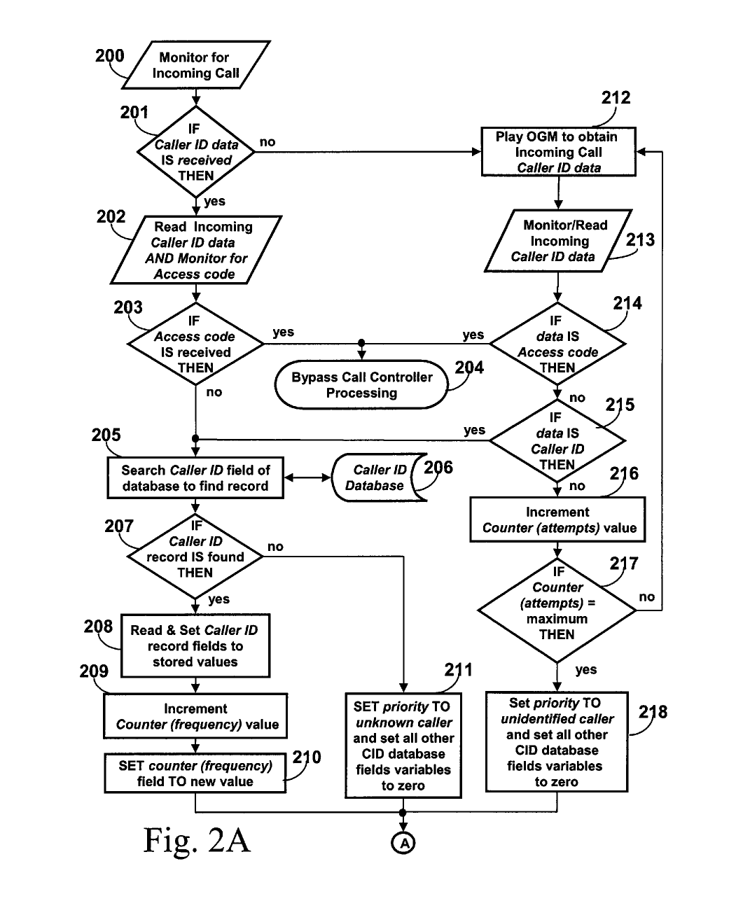

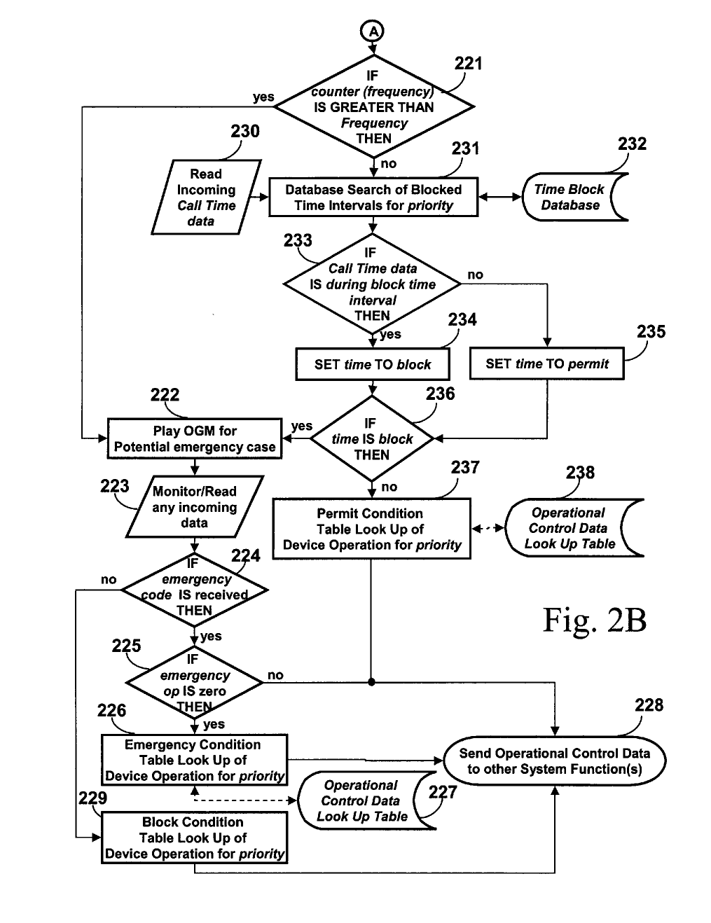

FIGS. 2A and 2B together form a flow diagram depicting the flow of operations carried out by the Communications Controller 100 system. The steps shown in FIGS. 2A and 2B provide an example of the control logic necessary to route and handle an incoming call. Operation commences at the monitor for an incoming call step 200, and upon the condition of an incoming call being received, a test is performed by Communications Controller 100 at decision block 201 to determine if the incoming Caller ID data is present. If the Caller ID data is present, it is read for further processing and monitoring for an access code input from the caller is performed at 202. A check is performed in 203 to determine if an access code is present. Upon receiving an access code, the Communications Controller logic is by-passed and the control of the call is routed directly to the Instantaneous Response Device 101 as indicated at bypass block 204. However, if the Caller ID data is not present, then at 212 an Outgoing Message (OGM) is played to request the caller to provide their Caller ID data. The Communications Controller 100 then monitors and reads the provided data as indicated at block 213.

A test is then performed at 214 to determine if an access code is present. Upon receiving an access code, the Communications Controller logic is by-passed and the control of the call is routed directly to the Instantaneous Response Device 101 as indicated at bypass block 204. However, if no access code is found at test 214, a check is performed at 215 to see if Caller ID data has now been provided by the caller. The Communications Controller 100 then monitors for Caller ID data to be received. If test 215 determines that Caller ID data is not received, the attempt to obtain Caller ID data from the caller is incremented 216. A check is performed at 217 to determine that the number of times the caller has been asked to provide their Caller ID is less than the maximum times permitted. If the maximum attempts are not exceeded, then Communications Controller 100 is programmed to send control information to the telephone device to hang-up or reiterate the request (OGM) to obtain the Caller ID information as indicated at block 212. This iterative process can reoccur a selected number of times based upon a maximum value. When the caller fails to provide valid Caller ID data after being provided with the maximum number of attempts, the priority of the phone call is set to an unidentified caller in block 218 to support further processing.

However, if test 215 finds that the caller has provided their Caller ID data, then a Caller ID database search is invoked at 205 on the Caller ID data field of Caller ID database 206. This search attempts to locate the record associated with matching Caller ID data field contents to the Caller ID currently determined. If the Caller ID match is found at matching test 207, then each field value of the matching record (for example: name, index, priority, OGM ID, announce ID, frequency, counter (frequency), duration and emergency operation) is read or obtained at 208 to support further processing. Then, the Counter(frequency) field is incremented at 209 and the new Counter(frequency) value is stored at 210 for further processing. (The purpose of this Counter(frequency) field is to provide the user with a pre-selected number of times a particular Caller ID can place a call over a specified period of time (say 24 hours) so as to limit being pestered by continuous calling from a particular caller.) If a Caller ID match is not found at 207, then the priority field value is set to indicate that the caller's identity (unknown caller) does not have a record associated to it in the Caller ID database 211. Also, all fields of a Caller ID record (for example: name, index, priority, OGM ID, announce ID, frequency, counter (frequency), duration and emergency operation) are set to zero to support further processing in block 211.

It is noted that the Caller ID data could either be caller dependent or device dependent. For example, the Caller ID data could consist of the originating call telephone number or I.P. Address for a network implementation for the device dependent data. Conversely, caller dependent data could consist of the caller video image data, speech pattern data, and/or personal account identification data.

If at test 221 the new Counter (frequency) field is found to be greater than the Frequency field (see FIG. 2B) of the record, then the Communications Controller 100 is programmed to send control information to the telephone device to inform (OGM the caller that the call is being blocked unless they indicate that the call is an emergency 222. This call is routed to the blocked condition with an opportunity to place an emergency call 222 since the number of allowed calls for a particular caller within a predetermined time period (say 24 hours) has been exceeded.

Processing commences at the Monitor for inputs from the caller in block 223. Check 225 is made to determine if an emergency code has been received. If no emergency code is received, the call will be possess a blocked condition 229. The blocked condition along with the determined caller priority condition will be used to lookup the consequential telephone operation data in 227. This relevant operation data of the device is read from lookup table 227 and the corresponding control data is sent to the system functions at 228 (shown earlier in FIG. 1) as required to support the operation specified (e.g., ring pattern, announce selection, OGM selection, record message, terminate the call, call forward, beep selection for call waiting, etc.). The operation control data that is retrieved from the Lookup Table 227 will be sent to the device functions and the call will be processed as a blocked condition 228.

If an emergency code has been received in check 224 then, another check 225 is performed to determine if the emergency operation code is valid. Upon a valid emergency operation code (this code is the consequential telephone operation data to be used for the conditions it supports), this consequential telephone operation data will be sent to the system functions 228. However, if the emergency operation data is not valid, the emergency condition 226 along with the determined caller priority condition will be used to lookup the consequential telephone operation data in block 227. The operation control data that is retrieved from the Lookup Table 227 will be sent to the device functions. The call will be processed as an emergency call 228.

However, if the new Counter (frequency) field is less than or equal to the Frequency field 221, then processing to determine the time blocks for the priority of the Caller ID will continue as indicated at 231.

The call time data is then read at step 217. The call time data includes the hour, minute, day, and date values the incoming call was received. A Time Block database 231 search is performed to obtain all blocked times 232 for the particular call priority. The call time data is compared to the time block intervals associated with the call priority. If at test 233 it is found that the time of the call is during a time block interval, then the time is set to “block” at 234 for the particular priority of the incoming call. However, if the time of the call is not during a time block interval 233 then, the time is set to “permit” for the particular priority of the incoming call 235. If time is set to “block” then the opportunity for the caller to classify their call as an emergency is presented 222. If time is set to permit 237, then the permit condition of the lookup table 227 is used to obtain the consequential telephone operation data as shown at 228.

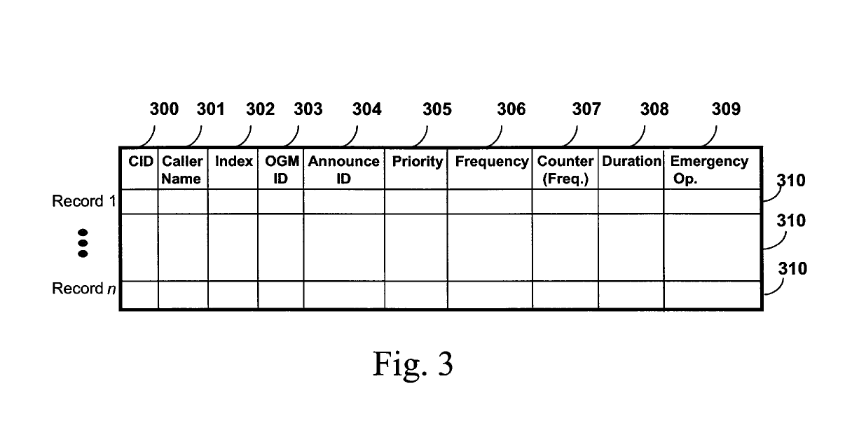

FIG. 3 depicts a caller database structure employed in one embodiment of the disclosed Communications Controller. The purpose of this database is to provide the Communications Controller with storage of incoming Caller ID data associated with the user's set priority data for that particular caller type. This database structure is employed by the earlier discussed Caller ID database search of FIG. 2A to obtain the priority of the incoming call.

This caller database structure includes a plurality of records 310 that are designated as Records 1 . . . n. As shown in FIG. 3, each record includes an incoming Caller ID (CID) field 300; a caller name field 301; an index field 302; an OGM ID field 303; an Announce ID field 304; a caller Priority field 305; a Frequency field 306 which contains the set limit or maximum number of times the caller can potentially ring through over a selected period of time; a Counter field 307 which cooperates with the Frequency field 306 to track the number of times a particular caller has placed a call within the selected period of time (e.g., 24 hours); a Duration field 308 (the duration field supports the user selected amount of time they typically allot to speak with a particular caller so as to budget their time); and an Emergency operation field 309 (this field contains the consequential telephone operation control data to be used for the conditions it supports).

The incoming Caller ID 300 is the unique identifier for the incoming call. With today's technology, the Caller ID is the call origination phone number. However, alternatively Caller ID 300 could be supported by speech/voice recognition data (namely unique speech or voice information), and/or image processing data (unique picture information) as well. The caller name field 301 can be used to store the name associated with the incoming Caller ID 300. The index field 302 is used for maintenance of the Communications Controller 100. Upon the database memory becoming inadequate to store additional records 309, the Communications Controller 100 can select a candidate based on which record is the lowest priority and is the most dormant per the index 302 indication. This candidate record memory allocation can then be used to store new data in these fields. The OGM ID 303 field contains an identifier for a specific OGM to be played for the particular Caller ID data. The Announce ID 304 field also contains an identifier for a specific Announcement to be played for the particular Caller ID data. The priority field 305 is used to store the relative priority of a Caller ID based on the user's needs/selection. For example, a representation of relative priorities is given in the following TABLE 1 wherein Priority 1 is the lowest priority and Priority 8 is the highest priority:

TABLE 1

Priority 1--harassment (lowest priority)
Priority 2--solicitations
Priority 3--friendly but not in the database
Priority 4--vendors/affiliations
Priority 5--work/business
Priority 6--secondary friends
Priority 7--primary friends/distant family
Priority 8--close family (highest priority)

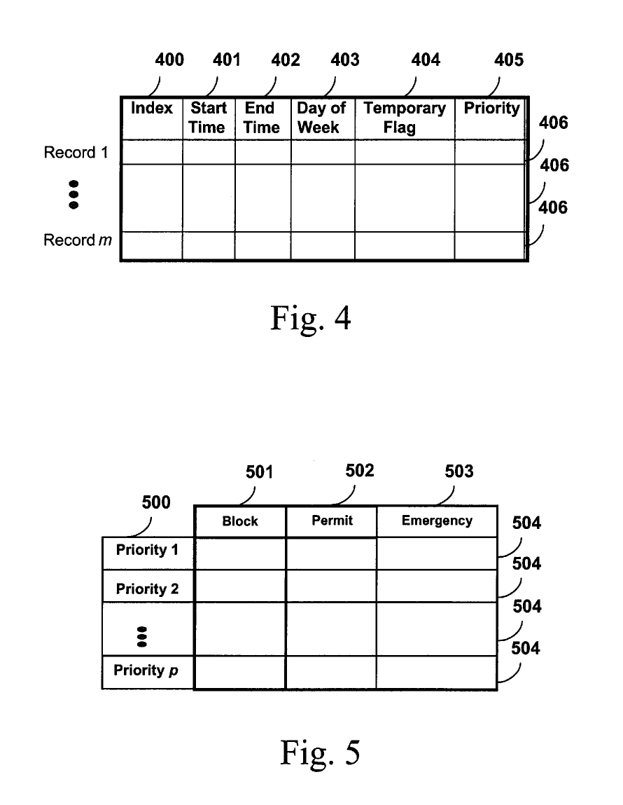

FIG. 4 depicts a blocking time database structure employed by one embodiment of the disclosed Communications Controller 100. This blocking time database structure is used by test 220 of FIG. 2B to determine if the incoming call is to be blocked or permitted based on the time of the call being received. The database structure includes a plurality of records 406 designated as records 1 . . . m. Each record defines a time block interval, namely an interval of time that the user does not wish incoming calls of specified priority to cause their telephone to ring or announce the caller.

Each of records 1 . . . m includes an index field 400, a block time interval start time field 401, a block time interval end time field 402, a day of the week field 403, a temporary flag 404, and the priority field 405. The index field can be used for internal Communications Controller 100 processing. The start time field 401 provides the hour and minute the time block interval begins. The end time field 402 provides the hour and minute the time block interval ends. The day of the week field 403 provides the days during the week that the time block interval is active. The priority field 405 is used to store the relative priority of a caller based on the user's needs. For example, a representation of a time block interval could be from 10:00 p.m. to 5:00 a.m., Sunday through Friday, blocking all priorities except Priority 8—family callers. The temporary flag field 404 is the flag that indicates the time block interval is temporary. This flag supports the silence mode of this invention. The Silence mode permits the user to select a relative period of time to block their phone calls. For instance, the next 2 hours put all calls in the block mode with user selected call priority exceptions.

FIG. 5 depicts a representative lookup table structure employed in the disclosed Communications Controller 100. The lookup table structure is used by tests 224 and 236 of FIG. 2B to obtain the consequential operation control data for the integrated telephone device functions. These consequences are based on conditional results being present. In particular, the lookup table structure includes a plurality of records 504 designated 1 . . . p, which is dependent of the number of caller priorities employed an any particular embodiment of Communications Controller 100. For example, in the disclosed embodiment wherein Priorities 1-8 are referenced in Table 1 above, p would have a value of 8.

With the combined conditions of the call being placed during the block time 501 and the priority 500 of the incoming call being specified, the desired consequential operation of the telephone device is defined. (It should be recalled that the controller retrieves the block time information from the blocking time database of FIG. 4 and that the controller retrieves the priority of the incoming call from the caller data base of FIG. 3.) With the combined conditions of an emergency call being placed during the block time 503 and the priority 500 of the incoming call being specified, the desired consequential operation of the telephone device is defined. Again, with the combined conditions of the call being placed during the permit time 502 and the priority 500 of the incoming call being specified, the desired consequential operation of the telephone device is defined. The operations of the telephone device include the Caller Identification Device Functions 103, Messaging Response Device Functions 102, and Instantaneous Response Device Functions 101. Some of these operations include but are not limited to the following:

Provide a specified ring pattern (of multiple ring pattern options)

Provide a specified announcement for a particular caller

Provide a specified OGM with or without an opportunity for the caller to leave a message (of multiple OGM options)

Terminate the call (e.g., hang-up without ringing the telephone device)

Call Forwarding/paging upon a call being routed to ring and the user pre-selecting this option

Call waiting will transmit a beep signal for the user while on the phone. This beep could be mapped to a priority level beep type to inform the user of the importance of the call prior to them disrupting their present conversation

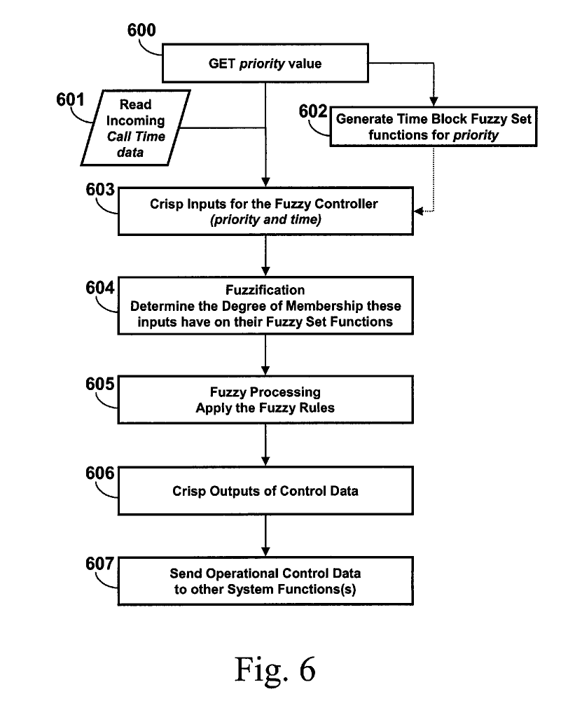

In one embodiment, a software implementation of the Communications Controller 100 can be coded to support the flow diagram of FIGS. 2A and 2B directly. This approach will be discussed later. However, another approach to the software implementation for the control logic of the Communications Controller is to employ Fuzzy Inference Logic (FIL). FIG. 6 depicts the flow diagram of the unique processing required to support FIL processing. It is noted that the same initial processing flow as depicted in FIG. 2A is employed to monitor for an incoming call. The priority is obtained at step 600 and the call time data is obtained at 601. Then fuzzy set membership functions are generated for that particular caller priority 602. The crisp values for the caller priority and time are obtained at 603 and are used to operate on the fuzzy sets of the FIL. This fuzzifies the data to a degree of membership relative to the values as indicated at step 604. Then, FIL rules are applied at 605. The rule that yields the strongest result is considered the consequential functional operation that the device should perform which is mapped to the crisp outputs as indicated at 606. This output operation control data is then routed to the other telephone functions at 607.

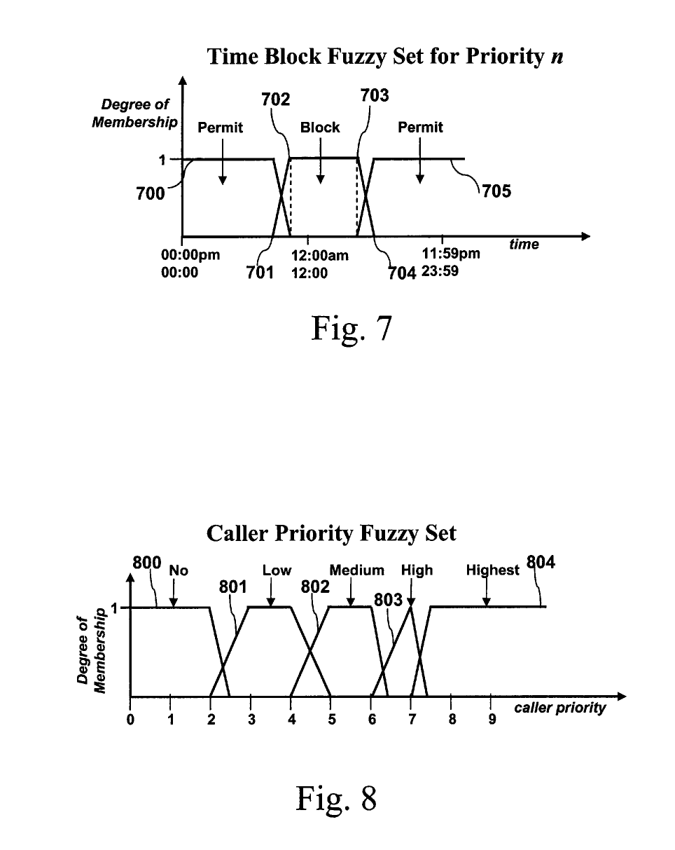

By way of example, the FIL implementation could utilize 2 conditional fuzzy sets. One conditional fuzzy set is for the block time conditions for a particular priority, a representation of which is shown in FIG. 7. The other conditional fuzzy set is the relative caller priority as depicted in FIG. 8.

The crisp inputs to this FIL are:

1) Relative values of actual time of call in hour/minute/day data

2) Relative value of caller priority as pre-selected by the user this example employs the following associated crisp values:

1=Priority 1—harassment (lowest priority)

2=Priority 2—solicitations

3=Priority 3—friendly but not in the database

4=Priority 4—vendors/affiliations

5=Priority 5—work/business

6=Priority 6—secondary friends

7=Priority 7—primary friends/distant family

8=Priority 8—close family (highest priority)

For a particular caller priority, the block time interval functions are generated based on the duration of the time interval. As seen in FIG. 7, one approach for achieving the time block interval functions is to have the function possess a degree of membership of 1 for 90% duration about its center between 702 and 703. The remaining 10% of the duration is divided between the intervals of between points 701 to 702 and 703 to 704. For example, if the block times interval started at 9:00 p.m. and ended at 6 a.m. yielding duration of 540 minutes, 90% of this interval is duration of 486 minutes 702 and 703, which would possess a degree of membership of 1. The remaining 54 minutes divided by 2 yields 27 minutes duration. For the starting point of the resulting function, the degree of membership is 0 ramping to a degree of 1 within the 27-minute duration 701, 702. For the ending point, the degree of membership is 0 at the end point of the block time interval and 1 within the last 27 minutes of the block time interval. Conversely, the permit time interval functions can be generated applying this same logic.

FIG. 8 depicts a representation of the Caller Priority Fuzzy Set. This Fuzzy set possesses the membership functions as they relate to the crisp priority input values. This representation maps the caller priority to the following relative incoming call conditions:

No priority 800

Low priority 801

Medium priority 802

High priority 803

Highest priority 804

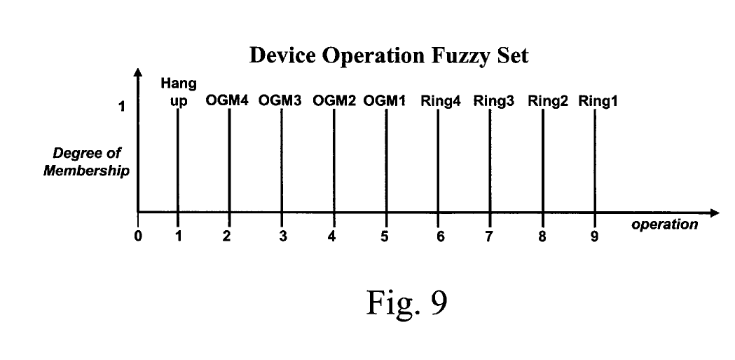

For simplicity, this example utilizes a Singleton output Fuzzy set for the consequential functional operations as shown in FIG. 9, which yields crisp outputs as follows:

1=hang-up=no priority call

2=OGM4=low/no priority OGM message

3=OGM3=medium priority OGM message

4=OGM2=high priority OGM message

5=OGM1=highest priority OGM message

6=Ring4=low priority ring pattern

7=Ring3=medium priority ring pattern

8=Ring2=high priority ring pattern

9=Ring1=highest priority ring pattern

It is noted that this Singleton crisp logic is directly applicable to the software implementation of FIGS. 2A and 2B. Also, other elements could be added to this Singleton logic such as the beep pattern type for different priorities of call waiting.

A representative set of Fuzzy Rules for these conditional Fuzzy Sets is as follows:

if Time is Block and Priority is No then Operation is Hang-up;

if Time is Block and Priority is Low then Operation is OGM4;

if Time is Block and Priority is Medium then Operation is OGM3;

if Time is Block and Priority is High then Operation is OGM2;

if Time is Block and Priority is Highest then Operation is OGM1;

if Time is Permit and Priority is No then Operation is OGM4;

if Time is Permit and Priority is Low then Operation is Ring4;

if Time is Permit and Priority is Medium then Operation is Ring3;

if Time is Permit and Priority is High then Operation is Ring2;

if Time is Permit and Priority is Highest then Operation is Ring1;

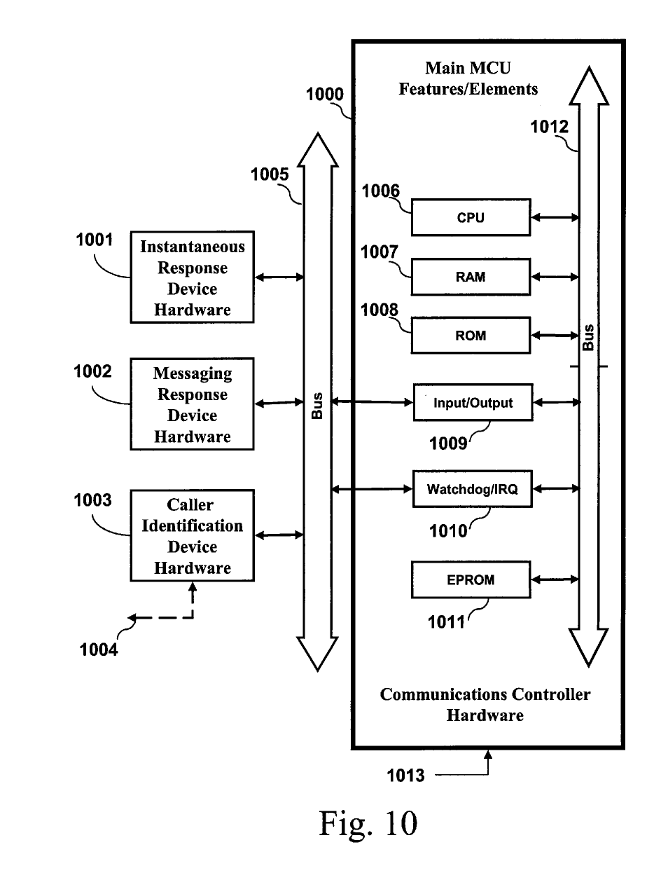

For the purpose of discussion, and not for the purpose of limitation, FIG. 10 depicts a high level hardware implementation of the FIG. 1 Communications Controller as Communications Controller 1000. Controller system 1000 employs a microcomputer (MCU). Utilization of a MCU for this type of application is a typical solution/implementation. However, the functions indicated in FIG. 1 can be integrated together or packaged separately in numerous configurations. These configurations can range from MCU's to Personal Computer Systems and/or a Telephony/Television System.

To clearly describe the hardware support functions required for the Communications Controller 1000 of FIG. 10, the following example of the steps performed upon receiving a call is explained along with details as they relate to the hardware of Communications Controller 1000. Communications Controller 1000 is coded with software according to the flow diagrams of FIG. 2A. This software code is stored in memory within controller 1000 in one embodiment. When executed by controller 1000, this software causes controller to implement the steps set forth in the flow diagrams of FIGS. 2A and 2B.

Data is received and transmitted across the Bus 1005 to permit the Instantaneous Response Hardware 1001 (e.g. a telephone), the Messaging Response Hardware 1002 (e.g. an answering machine) the Caller Identification hardware 1003, and Communications Controller 1000 to communicate.

Upon receiving a call via the communications line 1004, the Caller Identification hardware 1003 receives the incoming Caller ID data. An interrupt is then generated from the Caller Identification Hardware 1003 and sent to the Communications Controller Watchdog/IRQ 1010. This Watchdog/IRQ 1010 (e.g. an interrupt controller) monitors for reception of an interrupt that designates a call is being received. After this interrupt, the Caller ID data is transmitted from the Caller Identification Hardware 1003 via the bus 1005 to the Communications Controller MCU Input port(s) 1009. The data is transmitted via the internal Bus 1012 to the MCU RAM 1007.

This Caller ID data is then compared against data stored in ROM 1008 to obtain priority information as explained in the description of FIGS. 2A and 2B flow diagrams. CPU 1006 performs the processing software execution, which in turn provides the control logic for the controller according to the described flow diagrams. The RAM/ROM 1007/1008 provides the memory necessary to support the load of the executable code and memory to support the real-time processing. The EPROM 1011 provides the storage necessary to support the caller database of FIG. 3 and the blocking time database of FIG. 4 as well as the look up table of FIG. 5. The internal bus 1012 is used to support “local” communications among the various functions within the Communications Controller 1000.

In one embodiment, input values such as user selected priority and blocking time intervals are provided to communication controller 1000 by the user inputting such values to the Instantaneous Response Hardware 1001 (e.g. telephone device). These values are then transmitted to Communications Controller 1000 for storage in the memory therein. Alternatively, an input device such as a keyboard device or personal computer can be coupled to communications controller 1000 at input port 1013 to provide input for such values.

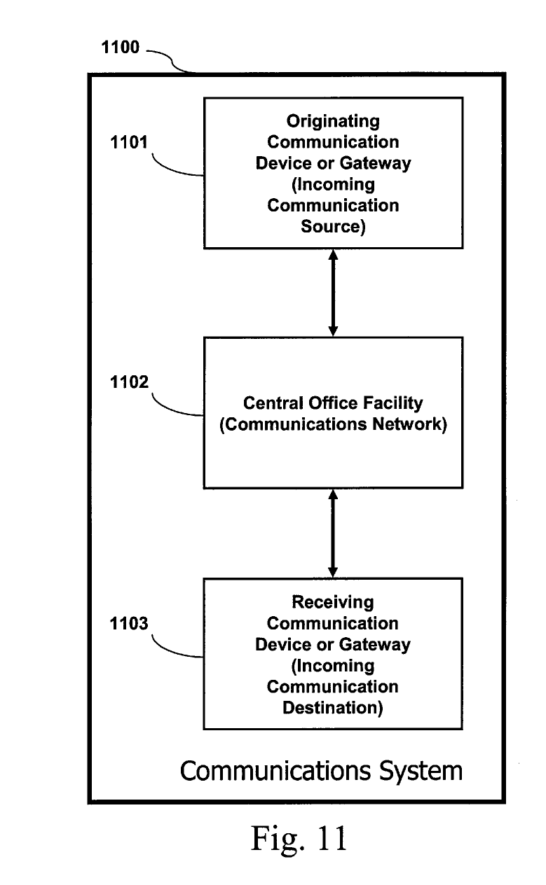

FIG. 11 is a functional block diagram showing the overall relationship of the disclosed Communications System 1100 which is comprised of the Originating Communication Device (Incoming Communication source) 1101, the Telecommunications Network Service Provider's Central Office Facility (Communications Network) 1102, and the Receiving Communication Device (Incoming Communication Destination) 1103 and sometimes a Gateway 1104. The processing provided to a particular incoming communication by the Communications Controller is originating source, conditional, and current receiving device mode setting dependent. It is noted that the Communications Controller and associative control logic can be applied and implemented as a consumer product along with other consumer communication devices (e.g. telephones, answering machines/services, Caller ID devices, computers, telephone/television/internet solutions, and wireless/mobile/radio devices, etc.). The Communications Controller can also be implemented at the telephone service switch at the Central Office Facility 1102 and provided to the consumer as a communication service.

In some instances, the Communications System may also include a Gateway 1104 which may be comprised of a PBX, VoIP, Hub, Server, etc. wherein a Gateway is defined as the function that provides communication management/control for the receiving communications device. In this embodiment, the Gateway 1104 will recognize the conditional emergency communication and “connect” the receiving party's communication device to the sending party communication device.

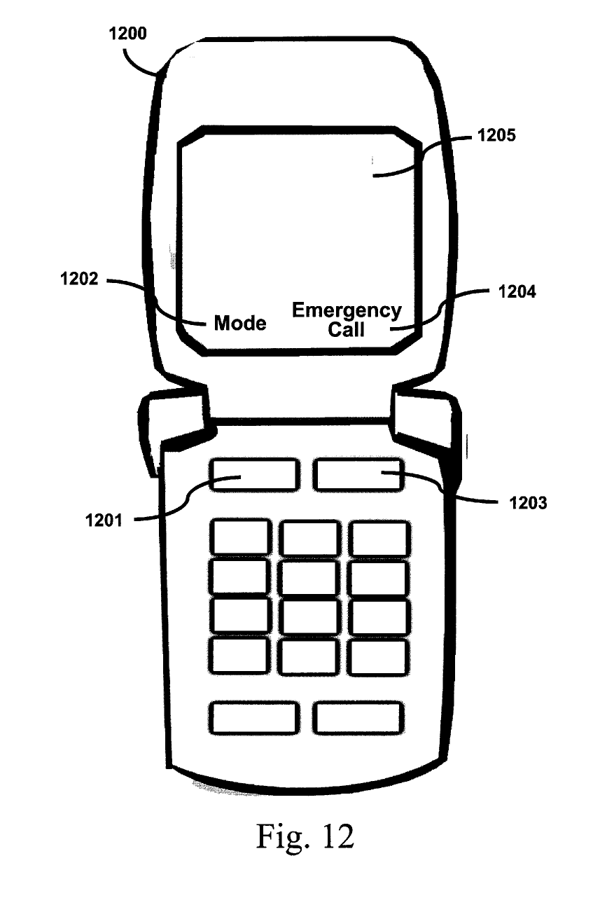

For the purpose of discussion, and not for the purpose of limitation, FIG. 12 depicts a mobile device 1200 that has the Communication Controller 100 embedded in it. For example of the user interface design, the soft keys 1201, 1203 may be programmed to support the functionality of the Communication Controller 100. Pressing soft key 1201 permits the user to toggle the emergency mode function on/off. The current mode 1202 of the device is displayed on the device screen 1205 above the soft key 1201.

Programmable key 1203 may be used to initiate a conditional communication. The conditional communication may be an emergency communication and or other varying conditional priorities. The Communication Controller 100 functionality for placing an emergency communication can be programmed to soft key 1203. This functionality is displayed 1204 for the user. In a panic situation, the user can merely “press” or “press and hold” the Make Emergency Call 1203/1204 soft key to send an emergency conditional communication. The press and hold function would send a communication to a default/stored contact(s). Upon just pressing the Emergency Call soft key 1203/1204 (i.e., not press and hold), an opportunity is presented to the user of the device to select or input the phone number/contact(s) information of the party they wish to send an emergency communication. Both the sending and the receiving devices require the Communication Controller 100 functionality to process conditional communication.

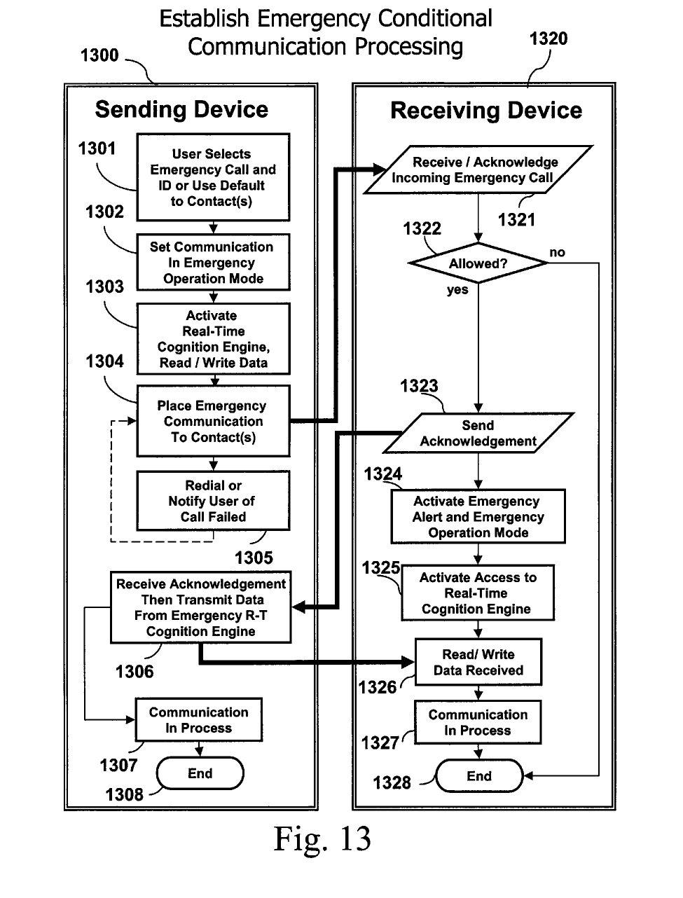

FIG. 13 forms an example of control logic flow diagrams carried out by the Communications Controller 100 system for conditional processing. More particularly, these diagrams support the emergency conditional processing flow. Upon placing a conditional communication, functional processes and means are initiated to support the conditional communication type wherein the conditional communication type may comprise varying degrees of urgency and/or priority such as an emergency condition, a critical condition, a normal condition, a low priority condition, etc. These conditional communications are supportive of intelligent situational awareness communication processing.

Operation commences in the Sending Device 1300 wherein the user places an Emergency Conditional Communication 1301 achieved by the process described for FIG. 12. Upon selecting a key programmed to send an emergency condition communication 1203, the communication mode is set to Emergency Operation Mode 1302. Associated processes and functions that comprise the Real-Time Cognition Engine 1303 (RTCE) are invoked (i.e., activation of associated processes and functions for the particular conditional communication).

The communication is placed within the Communications System 1100 to selected contact(s) 1301 also known as participants. Another means to transmit the emergency conditional communication 1304 is to establish a communication connection between the Receiving Device 1320 and the Sending Device 1300 by using TAPI (telephone application program interface) to append a unique string of DTMF signals that are automatically sent to the Receiving Device(s) 1320. A signal such as the said DTMF string would be unique to the emergency conditional communication 1304, 1321 (i.e., unique DTMF tone detection). This emergency conditional communication DTMF signal is transmitted and then a connection acknowledgement is sent from the receiving unit 1323. In the instance that the communication was not successful, automatic redialing is invoked 1305. If the communication completely fails, a notification is provided to the user of the sending device that the communication failed 1305. The identification of the incoming communication 1322 is checked in the receiving device 1320 leveraging the control logic of FIGS. 2a and 2b. If the communication is not allowed to alert the receiving party, it is terminated 1328. If it is permitted to alert the receiving party, an acknowledgement is sent to the sending device 1323 then the appropriate conditional communication alert is activated, in this case, the distinct emergency alert 1324. The mode of the receiving device is set for the incoming conditional communication type. In this case, the mode of the receiving device is set to the Emergency Operation Mode 1324. The receiving party is then intelligently alerted which is comprised of aural, tactical, and/or visual means or any combination thereof.

The acknowledgement 1323 can be accomplished using different methods. One method could be to leverage a DTMF signal that is recognized by the sending device 1300 Real-Time Cognition Engine once the said sending device is in Emergency Operation Mode 1302. Another method would be to leverage TAPI 2.2 or greater functions such as the lineMessage and line_devspecificfeature Message functions. The Receiving Device 1320 Real-Time Cognition Engine Access is then activated 1325. The Sending Device 1300 sends data and/or media 1306 to the Receiving Device 1320 which is stored Receiving Device memory and accessed 1326. The conditional communication is now established and in process 1307, 1327 until it is terminated 1308, 1328.

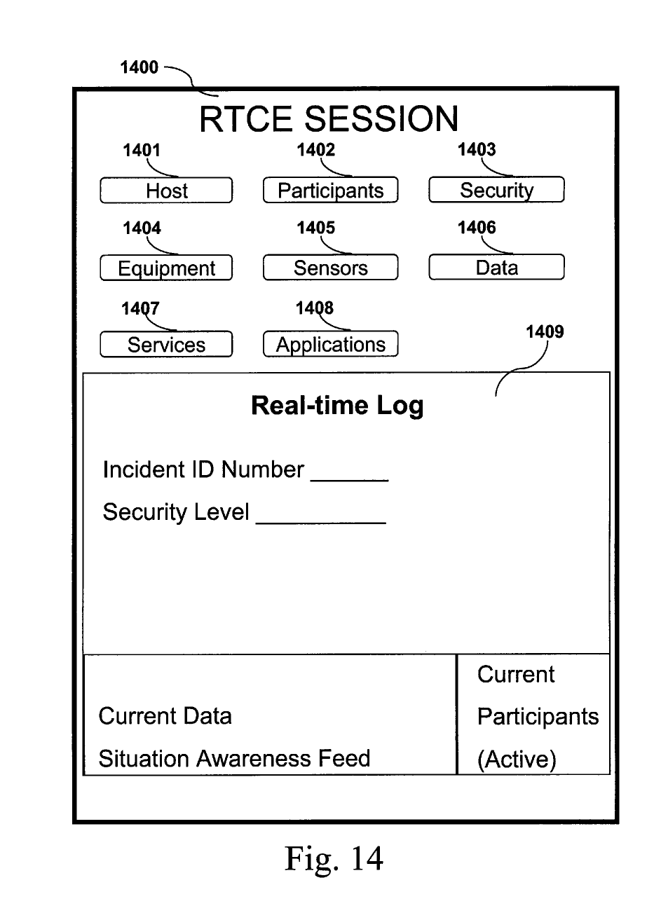

Activating the Real-Time Cognition Engine (RTCE) launches an Event Session, an example of which is depicted in FIG. 14. This can be accomplished leveraging Session Initiation Protocol (SIP) which is an application-layer control (signaling) protocol for creating, modifying, and terminating communication sessions with one or more participants. It can be used to create two-party, multiparty, or multicast sessions that include Internet telephone calls, multimedia distribution, and multimedia conferences. The sending party “hosts” 1401 the said Event Session as the host participant. An Event Session window 1400 provides access to shared communication functions needed throughout the communication until terminated by participating parties or some other means. The receiving parties are defined as participants 1402. The Security 1403 functions required for the Event Session are provided which comprise the security level needed for access to the session and/or the shared session data; the encryption needed, and authentication functions. The interface to obtain associated information and control equipment 1404, sensors 1405, and data 1406 is also provided in the Event Session window 1400. Services 1407 and additional Applications 1408 to support the Event Session can be accessed via the Event Session window 1400 as well. While the communication is being achieved into the Event Session resource memory creating a temporal log of events during the communication, it is also displayed in the window 1409 along with current situational awareness data. The active participants are also displayed in the said window. The log may be comprised of audio, video, multi-media, email, SMS, fax, data, and any other information from any source utilized and/or shared during the Event Session. Other information such as an Incident Identification Number and the Security Level may be displayed in the Event Session Window 1400. Multiple Event Session 1400 windows may be active to support a particular incident. For example, upon an event escalating from a jurisdictional level into a national incident, an Event Session 1400 may be established for unclassified incident resolution while another Event Session 1400 may be established for classified support of the incident. This means support interoperability among first responders and other government agencies/officials.

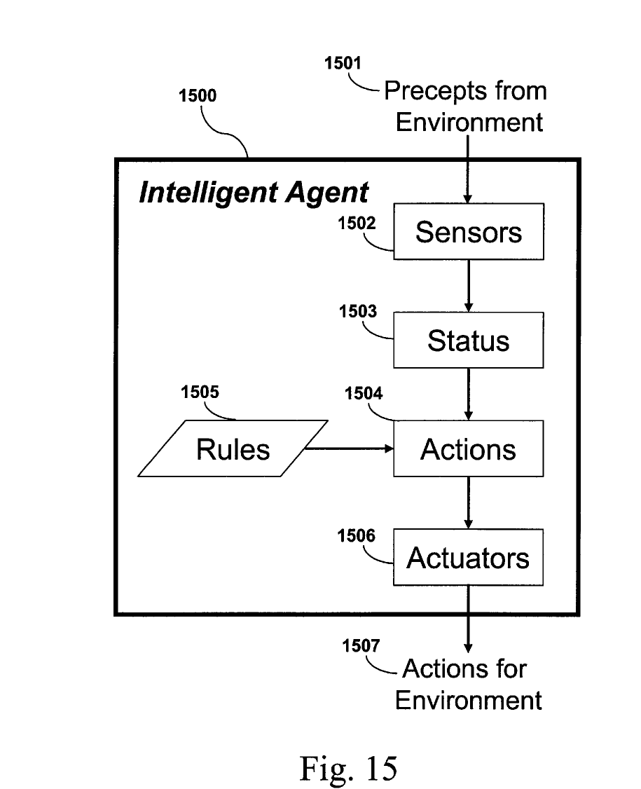

One implementation of the Real-Time Cognition Engine is through the use of a Multi-Agent System (MAS) comprising Intelligent Agents (IAs). FIG. 15 depicts fundamental elements of a simple IA wherein the Intelligent Agent 1500 program is a function that implements the agent mapping from Percepts 1501 to Actions 1507. Environmental Precepts 1501 are fed into the IA's Sensors 1502. The Status 1503 is “what the world is like now” for the IA. Given the said Status 1503 and applying the IA's Rules 1505, yields specific Actions 1504 taken by the IA. In a simple case, by finding a Rule 1505 that matches the current situation (as defined by the percept), perform the Action 1504 associated with that particular Rule 1505. These Actions 1504 are input into Actuators 1506 resulting in Actions taken for the environment of the IA. More complex IAs includes learning agents that may also be employed in the RTCE. The overall architecture of the RTCE comprises a collection of these specialized units or IAs wherein the cognition engine is a system as a set of representations and models that interchange information between these representations. Each unit functions as a cognitive mechanism to achieve a particular aspect of intelligence, such as upon perception of the incident, select appropriate action(s), etc. Coordinated dynamics of the RTCE as IAs yield an adaptive means to support interoperability of an emergency incident of varying degrees. Some key RTCE IAs comprises the following functions:
1. Speech Recognition Engine and Shared Speech
2. Security and Authentication
3. Applications/Services/Expert Systems/Databases/Data Repositories/Media
4. Situational Awareness
5. Communication/Quality/Priority

Prior to any activation or utilization of the RTCE, the communication solutions and associated resources need to be setup and/or registered to support security features which comprise the following initial and default settings:
1. Define Identities (owner, device, aliases, equipment, names, assignment, agency/organization, etc.).
2. Define security level(s) for said Identities and provide authentication information.
3. Setup access/permission to particular applications, services, expert systems, databases, data repositories, media, etc.
4. Provide security level minimum clearance required to access and control resources.
5. Set encryption means to conform to security requirements. This can be achieved by selecting known encryption standards to execute for the appropriate security level supported (i.e., National Institute of Science and Technology Data Encryption Standard (DES)).
6. “Pair” resources that may need to interface with each other during an incident. This can be accomplished via Bluetooth technology and/or local area network means (e.g., intranet). It is noted that the interface between said paired devices may need to be modified to support this embodiment.
7. The communication device and ownership/assignment of the device is registered for use in authentication and/or security support for future use.

The RTCE may employ discrete speech recognition to support the Event Session. This can be accomplished by uniquely leveraging a utility such as Speech Application Programming Interface or SAPI which is an API developed by Microsoft to allow the use of speech recognition and speech synthesis. A unique application of speech recognition embedded in the RTCE is to have this utility as a shared resource-one common speech engine that can be directed by any participant of the Event Session 1400. For example, during an on-going Event Session, a remote worker at the “incident area” may be rendered unconscious. A participant could issue a command to the speech recognition engine such as “Man-Down Check”. The “Man-Down Check” requires response from all participants. If no response is provided, it is assumed the particular participant or host that did not respond is injured and unable to support the Event Session. The resources “paired” to the injured party's communication device can then be controlled/accessed remotely via other participants of the Session Event. This provides remote access and control of resources even though the “local” personnel may be rendered incapable of performing tasks required to respond. A few examples of discrete commands recognized by said speech engine may comprise the following:
1. Access “resource name” wherein the person issuing the command is directing the speech utility to address a particular resource that is a known resource in the Session Event.
2. Status “resource name” wherein the state of the resource is polled and reported back to participants of the Session Event.
3. Reset “resource name” wherein remote control of a resource is achieved.
4. Shut-down or Terminate “resource name” wherein remote control of the resource issues the command to power-off the resource.

Command types/functions are supported via the Event Session 1400. For a location based example, Status “Host Sensor A” would activate the said Sensor A (which would have been paired to the “host” communication device during set-up) and obtain said sensor readings and report them back to the Event Session Current Data/Situational Awareness Feed 1409 for review by participants with the appropriate security clearances. Situational Awareness IAs are considered IAs that interface with sensors, devices, equipment, and environmental. These IAs provide data to the Event Session. For example, an equipment IA could provide the participants with the operation of a particular resource/device such as operation status (on/off, readings (low, normal, high, and malfunction), reset, etc.).

Security IAs employed comprises multiple security levels, authentication, encryption, and breech detection functions. Authentication is performed leveraging the Communications Controller logic in FIGS. 2A and 2B to ensure the initiator of the Event Session is not from a malicious source attempting a false alert and the source is authorized to issue an alert to establish/host an Event Session. The Event Session 1400 possesses a security level required to support the incident. This security level is displayed in the Event Session 1409 for all participates. The situation arises wherein the security level may vary among participants. For example, the security level may be set to “typical level” or unclassified for local jurisdiction participants responding to an incident. However, upon the said incident escalating to a national level, participants may join the Event Session at varying degrees of classified access levels. Data security is critical to maintain so standard encryption means may be leverage to encrypt the communication and data being shared during an Event Session. All data introduced into the Event Session must be tagged with the appropriate security level associated to the data content and source (e.g., “owner” of the said data; participant that provided the data to the Event Session). Only like security levels or above can access said data. If a participant needs to know information contained in the said data but does not possess the security level needed, other participants with adequate security level may extract elements that are not considered “classified” to disclose in efforts to resolve the current incident. Therefore, there may be more than one Event Session 1400 active for a particular incident (e.g., concurrent “typical level” session and “classified level” session).

Data and information sources of varying security and/or classified levels may need to become part of the RTCE Event Session 1400. Even though security measures are employed, further assurances to protect said data and information sources need to be implemented. This can be accomplished by making the data itself intelligent. Elements needed to realize intelligent data comprise the following:
1. Data structure—a known data structure of formatted fields.
2. Data creator—provides necessary elements, properties, information regarding the data to enable intelligent handling of said data; creates the final version of data (e.g., “writes” data file in accordance to the data structure).
3. Data handlers—IAs with rules and adaptivity to support varying events associated with the data and/or an Event Session 1400 upon which actions are taken on said data.

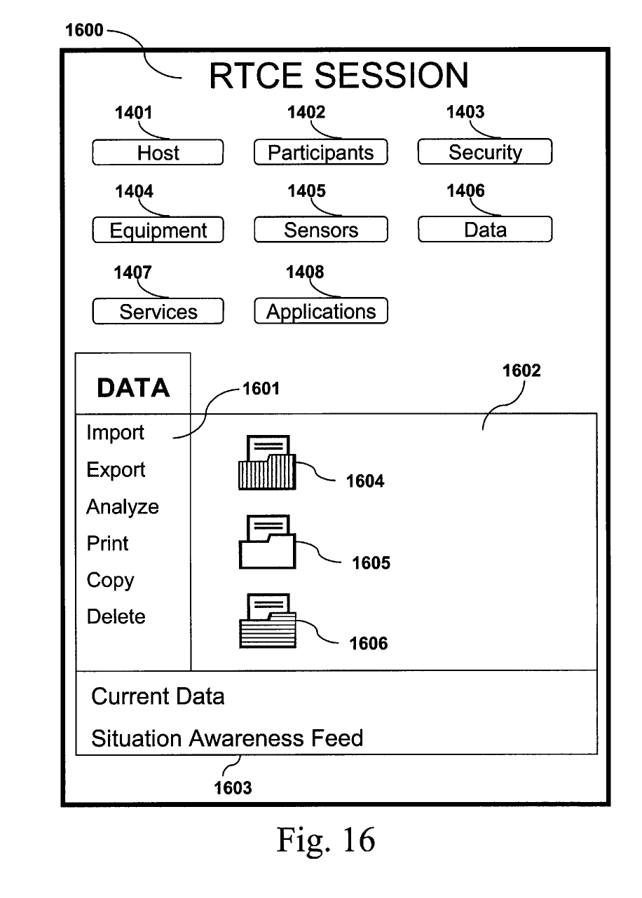

FIG. 16 depicts an Event Session Data window 1600. This window provides commands that can be executed on data during an active Event Session 1601. Current feed of the Situational Awareness data is constantly updated 1603 in this window. Data is displayed in accordance to the security level of the Event Session and the security permissions possessed by the participant accessing the data window 1602. For example, if a participant has a “Secret” clearance level, the said participant can access the Unclassified 1604 data, sensitive data 1605 and secret data 1606 by clicking on the respective icon displayed in the data access window 1602.

In order to contribute data in addition to and apart from the Situational Awareness feed 1603, the said contribution of data must be imported into the Event Session. Upon a participant selecting to import classified data into an Event Session, a data creator process would be invoked. This data creator process would obtain information either via input fields supplied by the participant or obtain information from the participant's communication device and generate a data file with the following field structure/attributes:
1. Owner—identification of the originating participant/agency
2. Time/Date—creation of data
3. Source—source data for creation of file
4. Data Name—name of data to be imported into the Event Session
5. Age—version control for IAs processing
6. Data Type/Format—identifier of the type of data beings imported (e.g., Microsoft Word Document, NTSC video, etc.)
7. Security—codes and/or levels identifying the minimum level of security needed to access the data being imported
8. Timer—this field permits the originating participant to set a timer on how long the data file can exist (this field enables the self-destruct IA upon the timer value equal to “time-out”).
9. Access counter—this field permits the originating participant to set how many times the data file can be accessed in the Event Session (this field enables the self-destruct IA upon the access counter value equal to “no access”).
10. Permitted Encryption—this field permits the originating participant to set the encryption standard required in order to manipulate the data (i.e., send the data from one device to another).
11. Tags—key words may be inserted that refer to the data that can associate said data to other like data in the Event Session (e.g., incident site at airport baggage handler number 5, tag=“airport baggage”; all data associated with airport baggage can therefore be grouped for additional reasoning/processing)
12. Allowable Actions—this field permits the originating participant to limit the actions permitted on the data by other participants of an Event Session (e.g., may prevent copying, printing, and allowing viewing only, which may be timed)
13. DATA—the actual data/data file being imported into the Event Session 1400.

The resulting intelligent data is imported into the Event Session for access by other participates with appropriate access and/or clearances. Once imported, data handlers manipulate and control the imported intelligent data. Data handlers are comprised of functions and actions executed during an Event Session supporting decisions and actions to be made regarding imported data. This application of creating data comprised of disclosed attributes along with data handler IAs enables the data to “self-manage” and make decisions taking necessary actions thus mitigating the risk of a breech or compromise of the data resulting in a security incident. Examples of data handlers' issues that leverage the intelligent data comprise the following:
Who am I?
Where am I? Where have I been? Is it safe or constrained?
How long do I have to live (event or time)?
Who am I associated with?
Who owns me? Who has seen me?
Where should I go?
How should I behave?
Who are you?
Should/can I tell you?
Do I have a problem and can it be fixed?

Data handlers addressing these issues can be grouped into the following primary categories:
1. Data Security Handlers: Controls access to data in the Event Session
2. Data Tracker Handlers:
3. Data Life Handlers
4. Data Analysis Handlers

To build Data Security Handler IAs 1500, the precepts from the environment 1501 wherein the environment is the Event Session 1400 within a communication solution (e.g., communication device, computer equipment, etc.) comprise perceiving the security level of the Event Session 1409, encryption used, participants and their security access levels, communication solution data (e.g., time, identification, etc.), and Event Session a priori identification data (known, unknown, unidentified). The display, keyboard, mouse and/or other input device/solution (e.g., wireless device touchpad/keypad display) is used as sensors 1502. Upon the host initiating a conditional communication such as an emergency communication in response to an emergency incident, a rule 1505 would be that the initial/default security level setting would inherit the minimum security level clearance among the host and participants the host contacts to initiate the Event Session. Another rule 1505 would be that if the participants are “known” (e.g., the participants' security levels are already known and information is stored in the host's communication device), the security level is set to the minimum known participant level. However, if a participant's security level is “unknown”, the level must be set to minimum so as not to compromise sensitive data/information. A final rule 1505 is upon the establishment of an Event Session and a participant's security level cannot be verified, the said participant's security is considered “unidentified”. Actuators 1506 comprise of setting the Event Session environment to the appropriate level. The Event Session 1400 window displays the appropriate security level.

To build Data Tracker Handler IAs 1500, the precepts from the environment 1501 wherein the environment is the Event Session 1400 within a communication solution (e.g., communication device, computer equipment, etc.) comprise perceiving the security level of the Event Session 1409, intelligent data imported into the environment, participants and their security access levels, communication solution data (e.g., time, identification, etc.), Event Session sensors, Event Session services, Event Session applications, and Event Session equipment. The keyboard, mouse and/or other input device/solution is used as sensors 1502. If for example, a participant uses the mouse and “clicks” on print 1503 to obtain a hardcopy of the intelligent data displayed in the Event Session window 1601, the IA senses the print request 1502 and applies rules 1505 comprising:

IF security acceptable THEN permit copying

IF security acceptable THEN permit printing

IF security acceptable THEN permit displaying

IF security acceptable THEN permit investigating

IF security acceptable THEN permit reporting

IF security acceptable THEN permit logging

IF security NOT acceptable THEN deny copying

IF security NOT acceptable THEN deny printing

IF security NOT acceptable THEN deny displaying

IF security NOT acceptable THEN deny investigating

IF security NOT acceptable THEN deny t reporting

IF security NOT acceptable THEN deny logging

Actuators 1506 comprise print, copy, save, import, export, report, log, tracking actions of individual participants within the Event Session environment (e.g., PARTICIPANT M print, PARTICIPANT N copy, etc.) etc. Upon the rule conditions being met, the desired participant action 1507 will be performed within the Event Session 1400.

To build Data Life Handler IAs 1500, the precepts from the environment 1501 wherein the environment is the Event Session 1400 within a communication solution (e.g., communication device, computer equipment, etc.) comprise perceiving the security level of the Event Session 1409, intelligent data imported into the environment, participants and their security access levels, communication solution data (e.g., time, identification, etc.), Event Session sensors, Event Session services, Event Session applications, and Event Session equipment. The keyboard, mouse, real-time session log, data, and/or other input device/solution is used as sensors 1502. If for example, a participant imports intelligent data into the Event Session that said participant designated to self-destruct after one hour due to the data's sensitive nature (i.e., intelligent data's “timer” attribute). The rule 1505 to support this action 1504 would be: IF “data name” timer EQUAL zero THEN overwrite data in memory wherein the “overwrite data in memory” would be the resulting actions for the environment 1507 thus destroying the intelligent data (self-destruct). Similar logic applies for event-driven actions.

To build Data Analysis Handler IAs 1500, the precepts from the environment 1501 wherein the environment is the Event Session 1400 within a communication solution (e.g., communication device, computer equipment, etc.) comprise perceiving the security level of the Event Session 1409, intelligent data imported into the environment, participants and their roles of support for incident management, communication solution data (e.g., time, identification, etc.), Event Session sensors, Event Session services, Event Session applications, and Event Session equipment. The keyboard, mouse and/or other input device/solution is used as sensors 1502. If for example, a sensor's data is polled at the on-set of an Event Session. The IAs compares the said reading to known levels to determine the status of the equipment the sensor is monitoring and apply rules such as the following:
IF reading IS GREATER THAN minimum AND LESS THAN maximum THEN equipment STATUS=NORMAL
IF reading IS LESS THAN minimum THEN equipment STATUS=FAULT_LOW READING
IF reading IS GREATER THAN maximum THEN equipment STATUS=FAULT-HIGH READING

IF reading IS EQUAL TO zero THEN equipment STATUS=OFF Actions may be to either attempt to correct the situation by software/hardware control means or reporting the status to the Event Session environment for participants to respond to accordingly. IAs can also activate other sensor/resources to resolve an issue.

While a method for controlling incoming communications and conditional communication cognition has been described above, it is clear a communications system for processing communications which include caller identification information is also disclosed. In summary, the disclosed system includes a caller identification device for receiving the incoming communication and extracting caller identification information from the incoming communication. The system also includes a user communications device for receiving and providing an incoming communication to a user of the communications device. The system further includes a communications controller coupled between the caller identification means and the user communications means. In one embodiment, the controller includes a processor for executing code to control the transmission of incoming communications to the user communications device. The controller further includes a memory for storing code for execution by the processor to control the transmission of incoming communications to the communications device. The stored code includes a caller database having a plurality of records, each record including caller identification information corresponding to a particular caller and a respective priority selected from a plurality of priorities. The stored code also includes a blocking time database having a plurality of records respectively corresponding to the plurality of priorities and including respective blocking time information for each priority. As discussed earlier in detail, depending on the time that a particular incoming communication is received and which of the plurality of priorities it is accorded, the communication is blocked, permitted or other appropriate action is taken. The controller also permits conditional communication for normal or emergency conditions.

In summary, the disclosed method and apparatus advantageously limits a communications device user's exposure to undesired communications by employing advanced control mechanisms implemented at or near the communications device in one embodiment. The control methodology and apparatus permits the consumer to proactively take control of how, when, and if the customer responds to incoming communications. Advantageously, the disclosed methodology transforms the communications device (e.g., telephone, computer, and/or television) from a passive device to a controllable device that incorporates individual time management values and customized consumer priorities. It also provides an intelligent means for unique processing of emergency communications. Incoming communications are managed and controlled depending on the time-of-day, frequency, type, emergency condition, and priority rating of the particular communications being received. In this manner, the user is empowered to take control over incoming communications.

While only certain preferred features of the invention have been shown by way of illustration, many modifications and changes will occur to those skilled in the art. It is, therefore, to be understood that the present claims are intended to cover all such modifications and changes which fall within the true spirit of the invention.

What is claimed is:

1. A method for processing conditional communication comprising the steps of:
a sending communication device initiating a conditional communication to a receiving communication device or devices whereas the conditional communication type is an emergency communication;
generating emergency indication criteria in the sending communication device;
establishing a communication link between the sending communication device and the receiving communication device;
sending the emergency indication criteria from the sending communication device to the receiving device or devices;
processing the emergency indication criteria and originating source criteria in the receiving device or devices to determine the operational functions to perform wherein operational functions comprise blocking the communication, using a distinctive alert for reception of the emergency conditional communication, using a non-emergency alert or alerts for reception of a non-emergency conditional communication, using a non-emergency alert or alerts for reception of a non-conditional communication, and terminating the communication;
creating a common event session for all participants of the communication; and
storing information and data from event session into memory.

2. The method of claim 1 further comprising the steps of:
searching a database comprising a plurality of records of originating source identification criteria for said source to block for conditional communications; and
upon an originating source identification criteria match, blocking the communication from alerting the receiving party.

3. The method of claim 1 further comprising the step of selecting, by the user, the respective originating source identification to be blocked for emergency conditional communication stored in the database.

4. The method of claim 1 further comprising the step of sending the emergency indication criteria as a unique DTMF signal indication.

5. The method of claim 1 further comprising the step of:
sending the emergency indication criteria as a unique SMS (Short Message Service) text message to the said receiving device; and
reading the said SMS text message to determine the emergency conditional communication.

6. The method of claim 1 further comprising the step of sending the emergency indication criteria leveraging TCP/IP protocol between the said sending device and the said receiving device.

7. The method of claim 1 further comprising the step of establishing a real-time cognition engine by utilizing the event session and intelligent data.

8. A method for creating and processing intelligent data comprising the steps of:
creating the intelligent data of a known data structure; comprising
attributes which at a minimum comprise owner, time/date, source, security, allowable actions and control parameters appended to original data source; and
processing attributes with intelligent data handler processes that apply rules to obtain the desired outcome.

9. The method of claim 8 further comprising the step of using intelligent agents for processing intelligent data.

10. The method of claim 9 further comprising the step of processing intelligent data to achieve cognitive data.
